(19) United States
(12) Patent Application Publication
(10) Pub. No.: US 2024/0253624 A1
(43) Pub. Date: Aug. 1, 2024

(54) IMPLEMENTING CONTEXTUAL SPEED LIMITS IN ISA SYSTEM HAVING BOTH POSITIONING AND SITUATIONAL-AWARE SUBSYSTEMS

(71) Applicant: 7980302 Canada Inc., Montréal (CA)

(72) Inventors: Raphael Jean, Montréal (CA); Gabriel Paquin Lefebvre, Montréal (CA); Mahamadou Kabore, Montréal (CA)

(21) Appl. No.: 18/428,235

(22) Filed: Jan. 31, 2024

Related U.S. Application Data
(60) Provisional application No. 63/442,402, filed on Jan. 31, 2023.

(51) Int. Cl. B60W 30/14; G06V 20/58; H04W 4/029

(52) U.S. Cl. CPC B60W 30/143; G06V 20/582; H04W 4/029; B60W 2420/403; B60W 2555/60

(57) ABSTRACT

A method for limiting a speed of a vehicle includes determining the vehicle's current location; capturing images of the environment in which the vehicle is traveling using a camera; processing the captured images using one or more deep neural networks; based on an output from the one or more deep neural networks, determining a context under which the vehicle is traveling and determining a seen posted speed limit if any applicable speed limit sign is sighted by the camera; in accordance with speed limit identification (“SLI”) logic, identifying a legal speed limit for the vehicle either based on the vehicle's determined current location or a determined seen posted speed limit; applying a speed policy to the identified legal speed limit to derive a practical speed limit; and determining a contextual speed limit by which to limit the vehicle's speed based on the practical speed limit and the determined context.

Any new and original work of authorship in this document is subject to copyright protection under the copyright laws of the United States and other countries. Reproduction by anyone of this document as it appears in official governmental records is permitted, but otherwise all other copyright rights whatsoever are reserved.

### BACKGROUND

Intelligent Speed Adaptation (ISA) systems are well known. Such systems may utilize positioning subsystems, such as Global Navigation Satellite System (GNSS), for determining location and associated map information saved in a database, including for example, speed limits, speed zones, and types of zones, such as school zones and work zones.

ISA systems also may utilize situational-awareness subsystems including detection and ranging subsystems whether based on sensors for detecting light or sound, and computer vision subsystems that utilize, for example, cameras.

For example, U.S. Pat. No. 9,085,237, incorporated herein by reference, discloses a speed limiter that recognizes a speed limit for a road on which a subject vehicle is traveling, based on an image captured by a front monitoring camera, and changes characteristics of throttle opening with respect to accelerator opening based on a difference between the vehicle speed and the speed limit.

U.S. Pat. Nos. 10,607,094 and 10,937,321, each incorporated herein by reference, disclose methods related to identifying an applicable speed limit for a particular lane in which a vehicle is traveling, wherein different lanes have different speed limits.

U.S. Pat. No. 10,896,337, incorporated herein by reference, discloses a method for classifying a traffic sign as a traffic sign sticker located on an industrial or commercial vehicle, or as a stationary traffic sign.

Additionally, U.S. Pat. No. 11,106,925, incorporated herein by reference, discloses that computer-assisted or autonomous driving vehicles use deep-neural-network-based object detectors for recognition of traffic signs. Moreover, the '925 patent discloses classification of traffic signs generated at least in part on computer vision.

Other U.S. patents incorporated herein by reference include U.S. Pat. Nos. 9,827,986; 10,417,910; 10,576,979; 11,030,898; 11,170,237; and 11,183,055.

It is believed that ISA systems that implement vehicular speed limits based only on a determination of location using a positioning subsystem do not work well in certain scenarios. For example, in the following scenarios such ISA systems may implement incorrect vehicular speed limits: out-of-date maps, or maps missing speed limits along newly constructed road segments; map matching errors; and rural areas.

ISA systems that implement vehicular speed limits based only situational-awareness subsystems also do not work well in certain scenarios. For example, such ISA systems may implement incorrect vehicular speed limits when turning into a new street/road/highway, because there is no guarantee that a speed limit will be posted in the next hundred meters. This also may occur when entering a highway, preventing the vehicle from reaching a safe highway speed. In California, for instance, the legal speed limit is 55 mph on two lanes of undivided highways unless posted otherwise. In practice, no speed limit is posted on those highways since the driver is supposed to recognize the situation. Thus, the vehicle could be stuck to a lower, potentially unsafe speed limit by an ISA system that relies on posted speed limits.

Such ISA systems that implement vehicular speed limits based only situational-awareness subsystems also do not work well when a next posted speed limit sign is not sighted by a computer vision camera. The could result from the posted speed limit sign being temporarily obstructed from view such as for instance, by a vehicle, by a trailer, or by a tree, thereby preventing the vehicle from reaching a safe highway speed. Also, in complex environments, multiple speed limit signs may be visible at the same time, and such ISA system may be unable to determine which speed limit signs are applicable to a lane in which the vehicle is traveling. Furthermore, vehicles such as trucks, trailers, and buses sometimes display speed limit signs or pictures of such signs for view by vehicles traveling behind them, which describe the maximum speed of such vehicles, and not a posted speed limit, and this may confuse such ISA systems. Another scenario is one in which speed limit signs indicate speed limits that are only for certain times, like school zone speed limits or nighttime speed limits.

On the other hand, ISA systems that utilize both positioning subsystems in conjunction with situational-awareness subsystems are believed to represent the state-of-the-art ISA systems and are the best performing ISA systems. See Exhibits C. D, and E of U.S. provisional patent application 63/442,402, which Exhibits are incorporated herein by reference. It also is believed that the use of ISA systems will become mandatory in some classes of EU vehicles, see Exhibit A of U.S. provisional patent application 63/442,402, which Exhibit is incorporated herein by reference, and the EU recommends prioritizing information from situational-awareness subsystems over information from the positioning subsystems, see Exhibit B of U.S. provisional patent application 63/442,402, which Exhibit is incorporated herein by reference.

ISA systems that use both positioning and computer vision subsystems are disclosed in U.S. Pat. No. 9,956,877, incorporated herein by reference. The '877 patent discloses a vehicle speed limiting device that establishes an upper limit for a running speed of a vehicle and controls a driving force so that the running speed of the vehicle does not exceed this upper-limit vehicle speed. The vehicle speed limiting device comprises a speed limit acquisition electronic control unit 10; an upper-limit vehicle speed setting electronic control unit 20; an engine electronic control unit 30; a meter electronic control unit 40; and an “ASL” operation unit 50.

The speed limit acquisition electronic control unit 10 is connected to an in-vehicle camera 11 and a navigation device 12. The in-vehicle camera 11 comprises an image sensor, such as CCD and CMOS, that acquires an image of the foreground of the vehicle. The speed limit acquisition electronic control unit 10 analyzes the images and acquires legal speed limits from road signs that are identified in the images. The navigation device 12 comprises a GPS receiver that detects a location of the vehicle. Using the location of the self-vehicle, the navigation device 12 extracts speed limit information for where the vehicle is presently traveling from road information of a map and outputs the speed limit information to the speed limit acquisition electronic control unit 10.

The '877 patent discloses that the speed limit acquisition ECU may be configured to adopt a speed limit acquired by assigning the in-vehicle camera 11 or the navigation device 12 with a predetermined higher priority, and may be configured to adopt a lower one or a higher one between the two speed limits when a speed limit acquired from the picturized image of the in-vehicle camera 11 and a speed limit acquired from the navigation device 12 do not coincide with each other. The '877 patent further discloses that, alternatively, only one or the other of the camera 11 and navigation device 12 may be used.

In view of the foregoing, it is believed that a need exists for an improved ISA system which makes better use of both a positioning subsystem and a situational-awareness subsystem. It is believed that such an improved ISA system can be realized by better considering context as determined based on information from each of the positioning subsystem and the situational-awareness subsystem.

As used herein. “context” refers to a set of one or more circumstances under which a vehicle travels in a given driving instance and relevant to the determination of an appropriate speed limitation to be applied by an ISA system. Examples of such context include pavement surface conditions (icy, wet, snow, dirt); road conditions (maximum speed limit signs, road work); traffic conditions; presence of other road network users (bike, pedestrians); and the type of road being traveled (divided highways, two lane undivided highways, residential areas, school zones). It is believed that enhanced consideration of context can be made using both the positioning subsystem and the situational-awareness subsystem that will result in a decrease of the chances of incorrect speed limitations being applied and diminish a need for methods for overriding such ISA systems by drivers. Additionally, it is believed that a need exists for such ISA systems that can be readily implemented by a vehicle fleet operator across a fleet of vehicles. Embodiments of ISA systems in accordance with one or more aspects and features of the present invention are believed to meet one or more such needs.

### SUMMARY OF THE INVENTION

In an aspect of the invention, a method for limiting a speed of a vehicle comprises the steps of: determining, at a vehicle, a current location of the vehicle as the vehicle is traveling; capturing images of the environment in which the vehicle is traveling using a camera at the vehicle; processing the captured images using one or more deep neural networks; based on an output from the one or more deep neural networks, determining a context under which the vehicle is traveling and determining a seen posted speed limit if any speed limit sign is sighted by the camera that is applicable to the vehicle as it is traveling; in accordance with speed limit identification (“SLI”) logic, identifying a legal speed limit for the vehicle based on the determined current location of the vehicle or a determined seen posted speed limit; applying a speed policy to the identified legal speed limit to derive a practical speed limit; determining a contextual speed limit by which to limit the speed of the vehicle based on the practical speed limit and the determined context; and limiting the speed of the vehicle to the determined contextual speed limit. Further in this respect, it is noted that the SLI logic is referred to as “dynamic fusion rules” in U.S. provisional patent application 63/442,402, from which priority is claimed.

In a feature, if a particular context is determined, then pursuant to the SLI logic a legal speed limit is identified based on the determined current location of the vehicle and not on a posted speed limit that is sighted. The particular context may be at least one of the vehicle traveling along an urban highway, the vehicle traveling along a rural highway, and the vehicle traveling in a school zone.

In a feature, if a particular context is determined, then pursuant to the SLI logic a legal speed limit is identified based on a posted speed limit that is sighted and not on a legal speed limit associated with the determined current location of the vehicle. The particular context may be at least one of the vehicle traveling in a work zone, construction zone, unmapped areas, and rural areas other than along a rural highway.

In a feature, one or more steps of the method are performed continuously.

In a feature, the method is performed by an ISA system of the vehicle.

In a feature, the limiting the speed of the vehicle to the determined contextual speed comprises outputting the contextual speed to a speed-limiting mechanism.

In a feature, the contextual speed limit is derived by applying a context profile to the practical speed limit. In a related feature, the context profile is applied in accordance with context priorities.

In a feature, the identifying of a legal speed limit for the vehicle based on the determined current location of the vehicle comprises accessing information from one or more databases maintained at the vehicle. In related features, the information is accessed using data representative of the determined current location of the vehicle; the information accessed comprises map information including one or more legal speed limits for a road segment corresponding to the determined current location; and the information accessed from the one or more databases maintained at the vehicle is updated on a regular basis as the vehicle is traveling. The information in the one or more databases located at the vehicle preferably is updated using a wireless transceiver that is configured for network communications through a network connection. The one or more local databases thus may be updated with current map information, weather information, speed policies, context profiles, and context priorities. SLI logic is also maintained in a local database and may be updated over the air via the wireless transceiver.

In a feature, determining a context under which the vehicle is traveling is also based on data from one or more sensors at the vehicle in addition to the captured images from the camera.

In a feature, the limiting the speed of the vehicle to the determined contextual speed limit cannot be overridden by a driver.

In a feature, the step of determining the current location of the vehicle is performed using a GNSS receiver or an IMU.

In a feature, the camera is a video camera that captures video in frames, each frame corresponding to a captured image.

In another aspect of the invention, an ISA system for limiting a speed of a vehicle comprises: a positioning subsystem configured to determine a current location of the vehicle as the vehicle is traveling; a situational-awareness subsystem comprising a camera configured to capture images of an environment in which the vehicle is traveling, including a speed limit sign if any is sighted by the camera that is applicable to the vehicle as it is traveling; one or more deep neural networks configured to process the captured images and configured to determine a seen posted speed limit for a sighted speed limit sign; a context estimator configured to determine a context under which the vehicle is traveling based on an output from the one or more deep neural networks; a speed limit identifier configured to (i) identify, in accordance with SLI logic, a legal speed limit for the vehicle based on the determined current location of the vehicle or the determined seen posted speed limit, and (ii) apply a speed policy to the identified legal speed limit to derive a practical speed limit; and a context implementor configured to determine, based on both the practical speed limit and the determined context, a contextual speed by which to limit the speed of the vehicle as the vehicle is traveling and configured to output the determined contextual speed to a speed-limiting device.

In yet another aspect of the invention, a vehicle having an ISA system for limiting a speed of a vehicle comprises: a positioning subsystem configured to determine a current location of the vehicle as the vehicle is traveling; a situational-awareness subsystem comprising a camera configured to capture images of an environment in which the vehicle is traveling, including a speed limit sign if any is sighted by the camera that is applicable to the vehicle as it is traveling; one or more deep neural networks configured to process the captured images and configured to determine a seen posted speed limit for a sighted speed limit sign; a context estimator configured to determine a context under which the vehicle is traveling based on an output from the one or more deep neural networks; a speed limit identifier configured to (i) identify, in accordance with SLI logic, a legal speed limit for the vehicle based on the determined current location of the vehicle or the determined seen posted speed limit, and (ii) apply a speed policy to the identified legal speed limit to derive a practical speed limit; a context implementor configured to determine, based on both the practical speed limit and the determined context, a contextual speed by which to limit the speed of the vehicle as the vehicle is traveling; and a speed-limiting device configured to limit the speed of the vehicle to the determined contextual speed limit.

In a feature, the vehicle further comprises one or more databases located at the vehicle containing map information, weather information, one or more speed policies, context priorities, and context profiles.

In a related feature, the map information comprises legal speed limits for road segments, whereby a legal speed limit can be identified based on the current location of the vehicle as it is traveling. The map information also preferably comprises road names, road types, and presence of zone types.

In a related feature, the weather information comprises weather reports including current weather conditions and forecasts for locations, whereby current or future weather can be identified for a location where the vehicle is traveling or may be traveling.

In a related feature, a speed policy comprises a maximum speed for each of a plurality of legal speed limits, by which the practical speed limit is derived. A speed policy further preferably comprises a maximum overspeed for each of or all of the plurality of legal speed limits identified in the speed policy, by which the practical speed limit is derived; the speed policy is applied to an identified legal speed limit in order to derive a practical speed limit.

In greater detail, the speed policy preferably corresponds to a user or to a company that is set by the user or by a representative of the company. If a speed policy corresponds to a company, then the same speed policy can be applied to all vehicles of the company. Alternatively, a plurality of speed policies may be provided for a company, with each speed policy corresponding to a particular driver or to a particular vehicle. Accordingly, in a related feature, each of the one or more speed policies corresponds to a particular driver or to a particular vehicle.

In a related feature, the context profiles comprise a maximum speed for each of a plurality of defined contexts. The maximum speed preferably is expressed as a percentage of the practical speed limit.

In a related feature, the context priorities comprise an order of priority of context profiles by which a context profile is implemented over one or more other context profiles. This is important because multiple contexts may apply to a given instance of the vehicle as it is traveling, and the corresponding context profiles for those contexts may differ. Accordingly, the context priorities resolve the problem of determining which of the multiple context profiles will trump the others and actually be applied to derive the contextual speed limit.

In a related feature, the ISA system comprises a wireless transceiver for network communication through a network connection, whereby the one or more databases are updated.

In a related feature, the one or more databases further comprise weather reports that are used in determining context.

In a feature, the context implementer is configured to determine the contextual speed limit using context profiles and context priorities.

In a feature, the speed limit identifier is configured to identify, in accordance with the SLI logic, a legal speed limit based further on a context that is determined by the context estimator.

In a feature, the context estimator is configured to determine a context based further on information accessed using the determined current location of the vehicle by the positioning subsystem.

In a feature, the context estimator is configured to determine a context based further on data from one or more sensors of the vehicle other than the camera.

In a feature, the speed-limiting device cannot be overridden by a driver of the vehicle.

In a feature, the context estimator uses data from the positioning subsystem in the determining of the context in which the vehicle is being driven.

In a feature, the speed limit identifier, in accordance with the SLI logic, uses the determined context in the identifying of a legal speed limit.

In a feature, the positioning subsystem comprises a Global Navigation Satellite System (GNSS) receiver.

In a feature, the positioning subsystem further comprises an inertial momentum unit (IMU).

In a feature, the positioning subsystem comprises a GNSS receiver and an IMU.

In a feature, the camera-based computer vision subsystem detects potential road work zones.

In a feature, the ISA system determines an implicit legal speed limit based on the determined context.

In a feature, the ISA system uses the one or more deep neural networks to classify speed limit signs by relevant types. The types preferably include regular speed limit signs; construction speed limit signs; variable speed limit signs; truck speed limit signs; night speed limit signs; day speed limit signs; and cautionary speed limit signs for which the speed limits are recommended (such as at exits, intersections, and curves). The ISA system also preferably classifies speed limit signs into types that are not relevant, including for example: speed limit signs for adjacent roads or lanes in which the vehicle is not traveling; speed limit stickers on the back of trucks and buses; and speed limit signs for non-motorized vehicles. Irrelevant speed limit signs preferably are not considered.

In another aspect of the invention, an ISA system comprises: one or more local databases comprising map information, one or more speed policies, and context information comprising context profiles and context priorities; a wireless transceiver for network communication through a network connection, such as an LTE connection or a Wi-Fi connection, by which one or more of the local databases are updated; a positioning subsystem configured to determine a current location of a vehicle as the vehicle is being driven; a situational-awareness subsystem comprising a camera and one or more deep neural networks configured to localize objects and classify objects or regions in frames received from the camera and determine a context of the vehicle as the vehicle is being driven; a speed-limiting device for limiting the speed of the vehicle to a speed as determined by the ISA system as the vehicle is being driven, such as a pedal controller or engine control unit; and a speed limit identifier, a context estimator, and a context implementer. The speed limit identifier uses speed policies in the one or more local databases to derive a practical speed limit from a legal speed limit that is identified based on data from the positioning subsystem. The context estimator determines a context in which the vehicle is being driven based on data from the situational-awareness system; and the context implementer, using the context profiles and context priorities in the one or more local databases, determines a contextual speed by which the speed-limiting device limits the speed of the vehicle as the vehicle is being driven based on the derived practical speed limit and the determined context.

In a feature, the one or more local databases further comprise weather reports.

In a feature, the speed-limiting device cannot be overridden by a driver.

In a feature, the context estimator also uses data from the positioning subsystem in determining the context in which the vehicle is being driven.

In a feature, the speed limit identifier, in accordance with SLI logic, also uses the determined context in identifying a legal speed limit.

In a feature, the positioning subsystem comprises a GNSS receiver and an inertial measurement unit (IMU).

In another aspect of the invention, an ISA system determines a legal speed limit based on information from a positioning subsystem and information from a situational-awareness subsystem, as disclosed herein.

In another aspect of the invention, a vehicle comprises an ISA system in accordance with any of the foregoing disclosed ISA systems.

In another aspect of the invention, a vehicle comprises an ISA system having means for determining a contextual speed limit as a function of information from both a positioning subsystem and information from a situational-awareness subsystem.

In another aspect of the invention, a vehicle comprises an ISA system having means for determining a contextual speed limit as a function of context profiles.

Additional aspects and features are also disclosed in the detailed description section below. Still further aspects and features are disclosed in U.S. provisional patent application 63/442,402 from which priority is claimed, the disclosure of which is incorporated by reference herein.

In addition to the aforementioned aspects and features of the invention, it should be noted that the invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

FIG. 1 is a schematic view of an embodiment of an ISA system in accordance with one or more aspects and features of the invention.

FIG. 2 is another schematic view in greater detail of an embodiment of an ISA system in accordance with one or more aspects and features of the invention.

FIG. 3 illustrates steps in a preferred method in accordance with one or more aspects and features of the invention.

FIG. 4 illustrates an exemplary graphical user interface (GUI) of a program associated with a preferred embodiment of an ISA system in accordance with one or more aspects and features of the invention.

FIG. 5 is an illustration showing another exemplary GUI for establishing a speed policy for use with a preferred embodiment of an ISA system in accordance with one or more aspects and features of the invention.

FIG. 6 illustrates identifications of legal speed limits with respect to speed limit transitions in accordance with one or more aspects and features of the invention when a vehicle travels from a rural area to an urban area and then back to a rural area.

FIG. 7 illustrates a vehicle traveling in an urban highway context.

FIG. 8 illustrates a vehicle traveling in a rural highway context.

FIG. 9 illustrates a vehicle traveling in a road work context.

FIG. 10 illustrates a vehicle traveling in a rural area context.

FIG. 11 illustrates a vehicle traveling in an urban area context and in a school zone context.

FIG. 12 illustrates a vehicle traveling in a hazardous weather context.

FIG. 13 illustrates a vehicle traveling in a variable speed context.

FIG. 14 illustrates a vehicle traveling in an unmapped road context.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast. “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

### Preferred System Hardware and Architecture

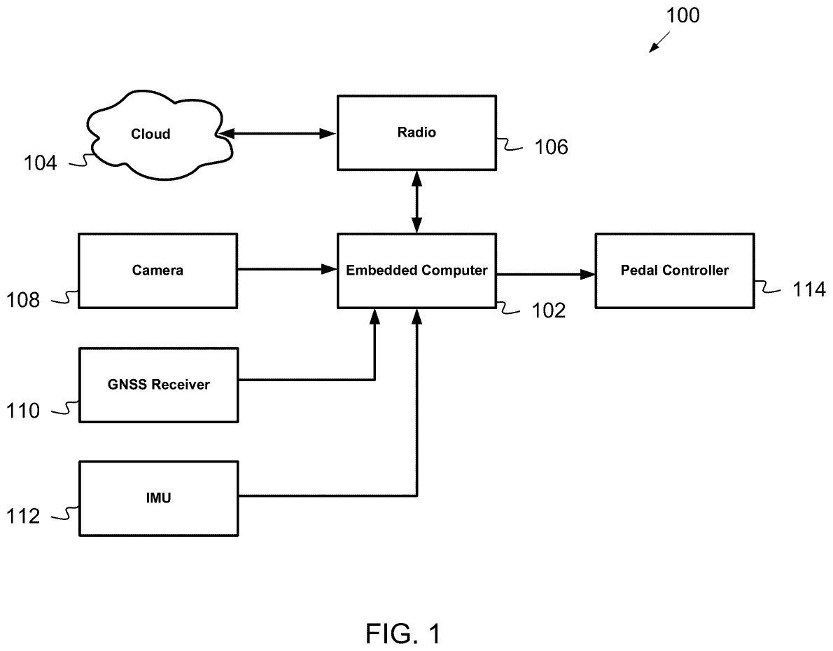

FIG. 1 is a schematic view of an embodiment of an ISA system 100 of a vehicle in accordance with one or more aspects and features of the invention. With reference to FIG. 1, the ISA system 100 comprises an embedded computer 102 on a vehicle, which synchronizes one or more local databases at the vehicle with one or more sources in the cloud 104 through a bi-directional radio communication device 106, such as an LTE connection or a Wi-Fi connection. Preferably the radio is not operated all the time, and the computer 102 stores information relevant to the ISA system 100, such as for example map information, context priority rules, context profiles, and weather reports, for access in real time anytime the vehicle is traveling. Accordingly, the information preferably is updated from the cloud using the radio on a regular basis.

Connected to the embedded computer 102 are sensors, including a camera 108, a Global Navigation Satellite System (GNSS) receiver 110, and an inertial momentum unit (IMU) 112. Other sensors can be included, such as a barometer, a rain sensor, etc. The embedded computer 102 processes sensor data in real-time and controls a maximum speed of the vehicle through a speed-limiting mechanism, such as an engine control unit or a pedal controller 114.

### Preferred Embedded Computer Processing

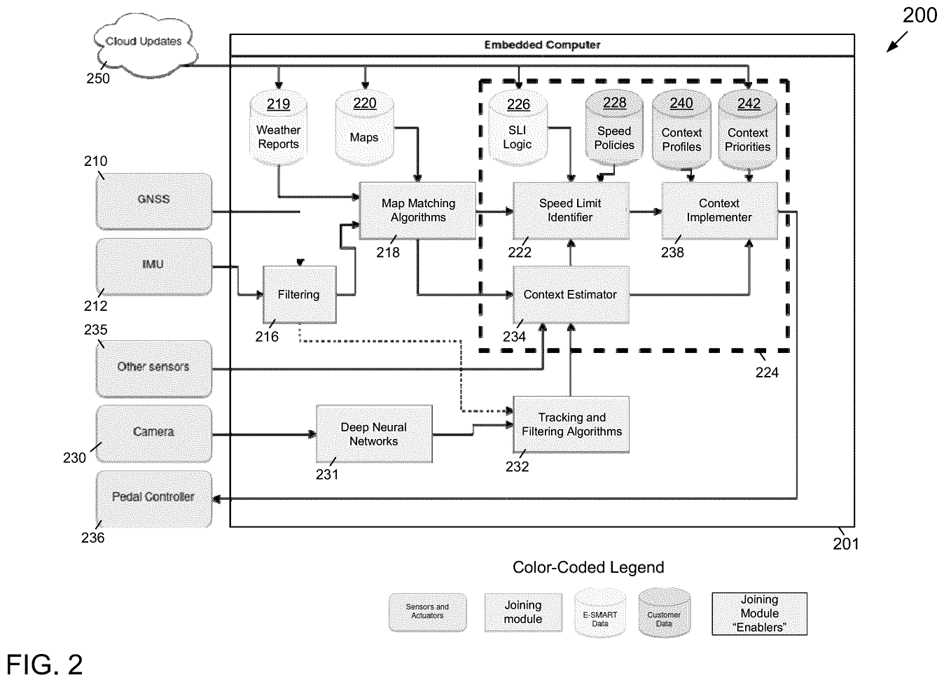

FIG. 2 is another, more detailed schematic view of an embodiment of an ISA system 200 in accordance with one or more aspects and features of the invention. FIG. 2 is believed to better illustrate preferred embedded computer processing. FIG. 2 shows an embedded computer 201 of a vehicle within which reside as logical constructs of the ISA system 200 one or more databases and one or more software subsystems or modules that perform various functions in accordance with one or more aspects and features of the invention. Furthermore, while various functions are attributed to different software constructs shown in FIG. 2, the software constructs may be combined or further segregated as desired so long as the functions are still performed. Indeed, the functions may be performed by a single program or multiple programs working together on one or multiple processors, microcontrollers, computers, and equivalents thereof in one or more modules or subsystems.

### Preferred Method of Operation

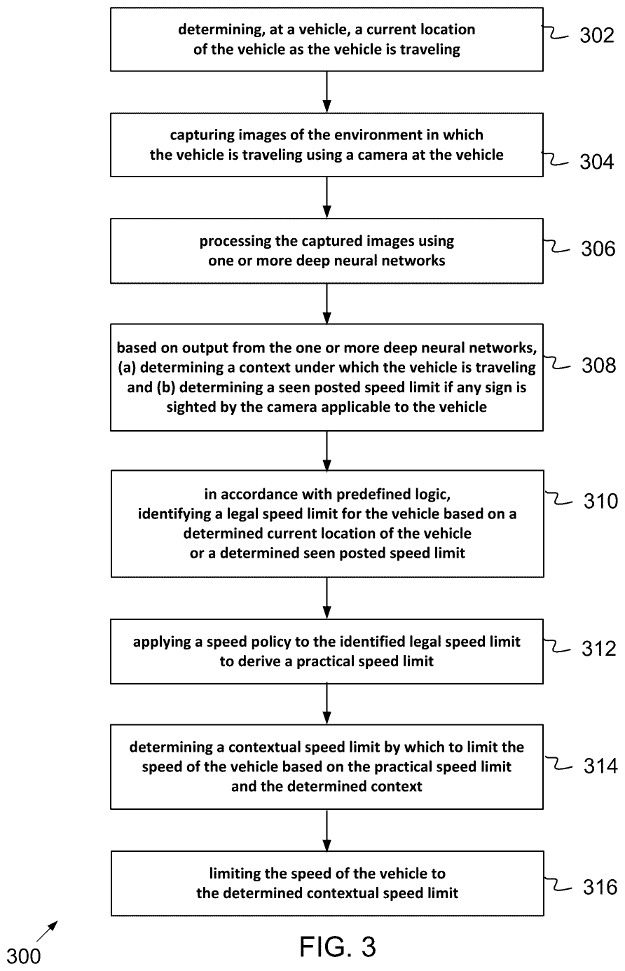

FIG. 3 illustrates steps that are performed in a preferred method 300. The method may be used in connection with a preferred ISA system such as the ISA system 200 of FIG. 2. The method also may be used in connection with a vehicle that either is operated by a driver or that is operated by an autonomous driving system.

The method 300 comprises a step 302 of determining, at a vehicle, a current location of the vehicle as the vehicle is traveling. This may be performed using a GNSS receiver 210 and an IMU 212. In order to provide an accurate estimation of position, data from the GNSS receiver 210 is combined with data from the IMU 212 using filtering methods at 216, such as Kalman filters. The filtered coordinates are then output to a map-matching algorithm 218, which identifies on which edge of a road network graph the vehicle is most likely traveling using map information associated with location in database 220. This edge is often referred to as a road segment.

The map information preferably includes not only legal speed limits but also other pertinent information regarding the locations, such as, for example, truck-specific legal speed limits, types of speed zones (school speed zone, work speed zone, etc.), road names, and road types (highway, on-ramp, rural street, divided highway).

Another map-matching algorithm preferably identifies the county name for the location and looks up a locally downloaded weather report in order to know the forecasted weather in real time, which is relevant to determining context. Another map-matching algorithm preferably finds the location of the sun relative to the direction of travel of vehicle in order to determine if visibility is affected by possible glare or darkness if twilight or nighttime at the particular location, which also is relevant for determining context.

This map information associated with the determined location is output to the speed limit identifier 222 of the embedded computer subsystem 224, which identifies in step 310 a legal speed limit for the vehicle in accordance with speed limit identification (SLI) logic maintained at the vehicle in database 226. Preferably, the SLI logic can be dynamically updated over the air such as by a user, administrator and/or fleet operator. The identification may be based on the determined current location of the vehicle or a determined seen posted speed limit, described below with regard to step 308.

The map information preferably is output for use by the speed limit identifier 222 when identifying the legal speed limit because, in certain situations, a speed limit identified by the situational-awareness subsystem (computer vision subsystem) may be preferred over a speed limit identified from the positioning subsystem, and vice-versa, as discussed below, and the map information is useful in applying the SLI logic in choosing which subsystem to rely upon for such identification. Thus, while the legal speed limit that is identified in step 304 is indeed based on the determined current location of the vehicle as the vehicle is traveling, which determined current location is used to access the map information associated with that location, the legal speed limit value itself may come from the situational-awareness subsystem and not from the map information depending, for example, on the speed zone or road type that is part of the map information output using the determined current location.

In either scenario. i.e., regardless of whether the legal speed limit is identified from the map-matching positioning subsystem or from the computer vision subsystem, a speed policy stored in database 228 is accessed in order to derive in step 312 a practical speed limit to output to a context implementer 238.

In step 314 a contextual speed limit is determined by the context implementer 238. The contextual speed limit is determined based on the practical speed limit and a context that is determined in step 308, discussed below. The determined contextual speed limit is used to limit the speed of the vehicle in step 316.

Thus, following identification of a legal speed limit and the subsequent derivation of a practical speed limit by applying the speed policy to the identified legal speed limit, and following the determination of a context by the context estimator, a contextual speed limit is determined by the context implementor. The contextual speed limit to which to limit the speed of the vehicle is based on the identified legal speed limit output by the speed limit identifier and the determined context that is output by the context estimator.

Turning now to step 308 and antecedent steps 304 and 306, in step 304 images of the environment in which the vehicle is traveling are captured using a camera 230 at the vehicle. Capturing the images may be done generally right before, right after, or concurrently with performance of step 302. Preferably, both steps are carried out on a continuous cycle. The captured images from step 304 are processed using one or more deep neural networks 231 at step 306. These deep neural networks 231 may be used to localize and classify objects or regions of the captured pictures. Tracking and filtering algorithms are applied by a tracking and filtering algorithms module 232. In this regard, an object detector can be used to find the locations of speed limit signs and road work signalization devices, such as cones. Crops of those objects can then be fed to more specialized classifier networks, for instance, to read the value on a speed limit sign. Furthermore, multiple observations of the same object can be used to improve confidence. Apart from thereby reading posted speed limits of sighted speed limit signs, information such as whether the vehicle is traveling through a work zone can be gleaned from, for example, counting the number of road work signalization devices sighted in the last few seconds. The type of road also likely can be determined based on analysis of the captured images, which also is relevant to determining context. Various visual cues can be used to determine if the vehicle is traveling on a highway, a rural road, or in an urban area, and by averaging probability across the last ‘n’ frames. The road condition likely can be determined based on analysis of the captured images, too. Condition of the pavement, such as dry, wet or icy, or the visibility condition, such as clear, cloudy, rainy, or snowy, can be determined from such analysis, which is relevant to determining context.

In step 310, a context is determined under which the vehicle is traveling by the context estimator 234 based on the classifications made using the deep neural network(s) 231. The determination by the context estimator 234 can also be based on data from other sensors 235 of the vehicle such as a barometer. The determination by the context estimator 234 can also be based on weather information that is obtained from a database 219 of the positioning subsystem.

Context estimator 234 outputs to the speed limit identifier 222 the legal speed limits that are read from processing of the image data acquired by the camera 230. Additionally, a precise location of the sign relative to the vehicle also may be output, especially if there are multiple lanes in the direction of travel with differing speed limits for the lanes. This enables the speed limit identifier to select a legal speed limit from the positioning subsystem or from the computer vision subsystem using the SLI logic in database 226.

It should be appreciated that certain steps of the method 300 are not dependent on one another in the sequence shown in FIG. 3. Any dependency between steps instead is disclosed through explicit antecedent reference herein; however, the steps are all performed within a short period of time such that the determined location and determined context correspond with each other and the speed to which the vehicle is limited is actually relevant to the determined location and determined context. All steps are performed in real time and nearly concurrently.

It will be noted that a context that could be determined would be a possible presence of road work, which could be output by the computer vision subsystem, or a combination of the computer vision subsystem and the map-matching positioning subsystem. Another context that could be determined is hazardous road conditions, such as “slippery”, which can be established by looking at the weather report for the current location indicating heavy rain and/or at the output from the computer vision subsystem indicating a wet pavement surface or rain on the windshield. A context that can be determined relates to the road type, such as “highway”, “school zone”, “rural”, “urban”, which can be established by looking at the map information for the current location that is output by the positioning subsystem and/or at the output from the computer vision subsystem indicating a highway sign, school sign, rural geography and/or rural geography.

This contextual speed limit that is determined in step 312 preferably is performed using context profiles stored in database 240 and context priorities stored in database 242, discussed in further detail below. Preferably, if a context cannot be determined then that itself is deemed a context (i.e., “unknown”) and processed according to the context profile for the unknown.

In step 314 the speed of the vehicle is limited to the contextual speed limit by output to, for example, an engine control unit or a pedal controller 236 or to some other mechanism that is configured to limit the vehicle's speed.

Of note, preferably one or more of the databases 219,220,226,228,240,242 are wirelessly updated over the air with current data from one or more servers in cloud 250 while the vehicle is traveling. The one or more databases preferably are relatively current and available for use even when wireless communications are unavailable, which may occur from time to time as the vehicle is traveling.

Additionally, a camera feed from the camera 230 preferably is output frame per frame to different deep neural networks 231 in order to find speed limit signs as well as information relevant to the driving context, such as road work zones, wet or icy roads, or rain on the windshield. Since the output of neural networks is never completely reliable, it is then output to the tracking algorithms and/or filtering algorithms 232 to decrease the error probability to within acceptable boundaries.

From the foregoing, it will be appreciated that the speed limit identifier 222 receives map-matched legal speed limits output from the map matching algorithms 218, along with read legal speed limits output from the computer vision subsystem via the context estimator 234, and that in response the speed limit identifier 222 outputs a practical speed limit by selecting, in accordance with predetermined logic 226, one of the map-matched legal speed limit and the read legal speed limit, and applying thereto a speed policy. The SLI logic preferably is common to all implementations of ISA systems for a fleet and is updated through the cloud 250 and can be adjusted or revised by a fleet operator/administrator in real time to offer the best possible estimation for the legal speed limit and, in return, the practical speed limit. Heuristic-based expert knowledge can be used, a data-driven approach using machine learning models can be used, or a combination of both, in tuning and improving the SLI logic in real time.

Further in this respect, it will be appreciated that the SLI logic provides the rules for selecting the legal speed limit based on which a practical speed limit will be determined by applying a speed policy. The SLI logic determines which legal speed limit should be used from all the available sources, i.e., from the map-based positioning subsystem and from the situational-aware/computer vision subsystem.

Examples of SLI logic for identifying the legal speed limit include: using the legal speed limit from the positioning subsystem at startup of the vehicle; using the legal speed limit from the positioning subsystem when turning on a new road; using the legal speed limit from the positioning subsystem when leaving an area with a reduced speed limit, for instance, when leaving an urban zone or a roadwork zone; and using the legal speed limit from the positioning subsystem when entering a reduced speed limit zone, such as a school zone.

Examples of logic for identifying the legal speed limit that is used from the computer vision subsystem include: using the legal speed limit from the computer vision subsystem when in a roadwork zone and a new speed limit sign is read; and using the legal speed limit from the computer vision subsystem when neither on a highway nor in a school zone, and a new speed limit sign is read.

The SLI logic can be changed dynamically by the user, administrator and/or fleet operator on a per-client basis in order to optimize the overall system performance based on telemetry data and customer feedback to allow the selection of the most probable speed limit.

With further regard to context profiles and context priorities, a user, administrator and/or fleet manager can establish driving parameters based on the context that is determined and extent of control of the vehicle by the ISA system. Driving parameters can include whether cruise control can be activated or a maximum allowed speed limit in contexts. In this respect, a context profile is defined and customized for each available context by the user, administrator and/or fleet manager. For instance, in normal operation, the allowed speed limit could have a slight buffer, for instance, 5% over the speed limit. When entering a possible road work zone, instead of a 5% buffer over the speed limit, a 5% decrease in speed could be enforced without the possibility of activating the cruise control. In order to keep the applied speed limit easily explainable, only a single profile preferably is applied at a time. For instance, if the road is slippery and the vehicle is in a roadwork zone, the profile can be either “roadwork” or “slippery”, based on a customer-defined priority list.

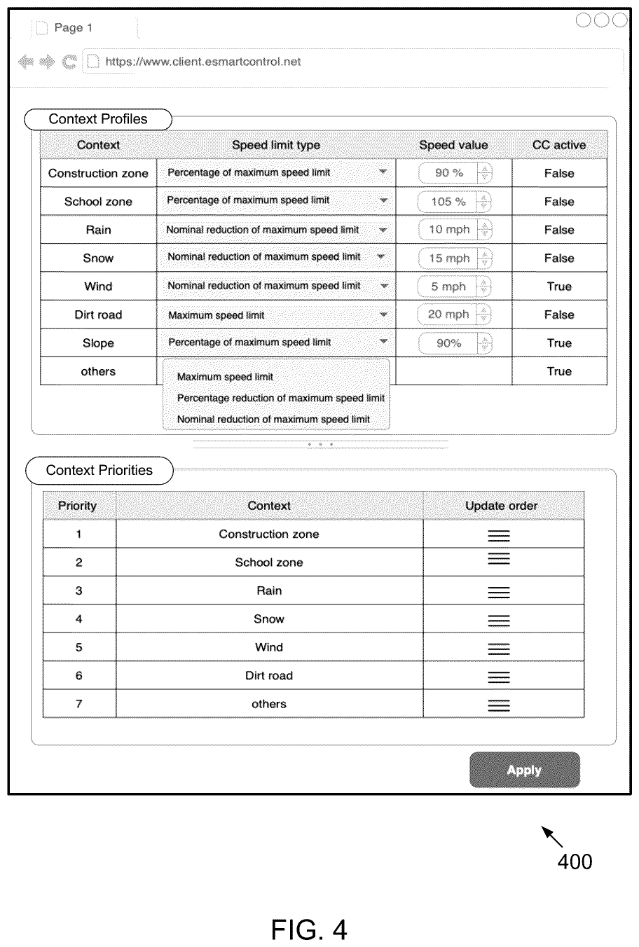

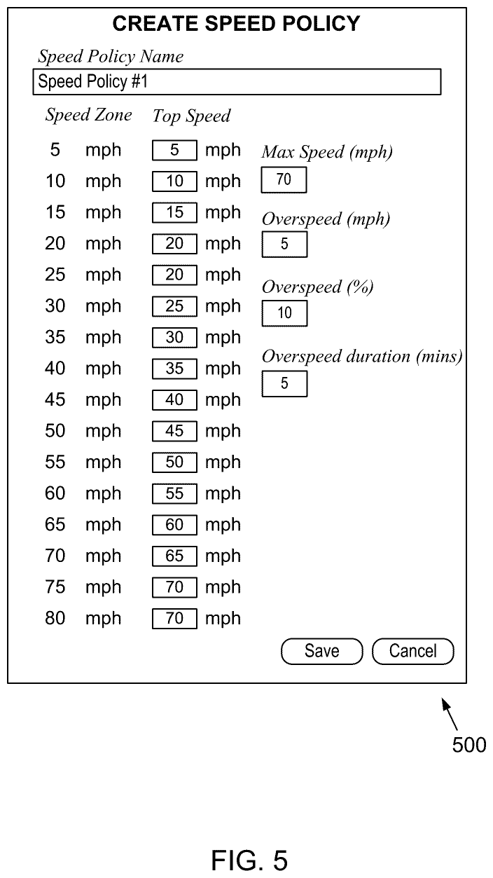

FIG. 4 illustrates an exemplary GUI 400 of a program associated with an embodiment of an ISA system in accordance with one or more aspects and features of the invention, wherein various context profiles and context priorities that can be customized through the GUI by a user, administrator and/or fleet manager. FIG. 5 is an illustration showing another exemplary GUI 500 by which a speed policy is created in accordance with one or more aspects and features of the invention.

### An Example of Identifying Legal Speed Limits: Rural Area Transitions

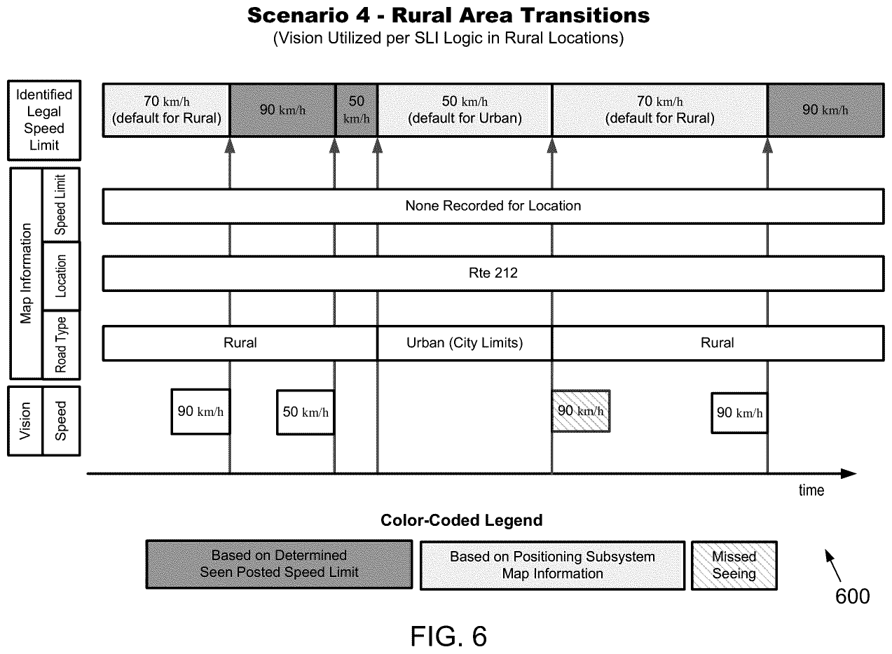

FIG. 6 illustrates exemplary identifications of legal speed limits with respect to speed limit transitions 600 that occur as a vehicle travels from a rural area to an urban area and then subsequently back to a rural area. It will be noted that, in accordance with this exemplary illustration, as a vehicle travels through a rural area as revealed by the map information, the identified legal speed limit is 70 km/h in accordance with the SLI logic, which represents a default speed limit for a rural area because the map information does not include any speed limit information associated with the current location of the vehicle.

While continuing to travel through the rural area, a posted speed limit sign is sighted by the computer vision subsystem and a seen posted speed limit of 90 km/h is identified at the legal speed limit at that point in time in accordance with the SLI logic.

Subsequently, while continuing to travel through the rural area, another posted speed limit sign is sighted by the computer vision subsystem and a seen posted speed limit of 50 km/h is identified at the legal speed limit at that point in time in accordance with the SLI logic.

Thereafter, the map information accessed based on the vehicle's current location indicates that the vehicle is passing into an urban area. In accordance with the SLI logic, the identified legal speed limit is then based on the map information of the positioning subsystem and not on a seen posted speed limit from the computer vision subsystem. Since the map information does not have speed limits recorded for the current location, the default speed limit of 50 km/h is identified.

While traveling through the urban area, no posted speed limit sign is sighted by the computer vision subsystem.

At a later point in time, the map information accessed based on the vehicle's current location indicates that the vehicle is passing back into a rural area. At this juncture, a posted speed limit sign of 90 km/h is missed by the computer vision subsystem. In accordance with the SLI logic, the identified legal speed limit is then based on the map information of the positioning subsystem or a seen posted speed limit sign from the computer vision subsystem. Since the map information does not have speed limits recorded for the current location, and since no posted speed limit has been seen, the default speed limit of 70 km/h for the rural area is identified from the map information of the positioning subsystem. If the ISA system were relying only on the computer vision subsystem, then the identified speed limit would have remained at 50 km/h, creating a potentially unsafe and definitely frustrating travel situation.

Subsequently to entering the rural area again, another subsequent posted speed limit sign is now seen by the computer vision subsystem. While traveling back in the rural area, in accordance with the SLI logic, the identified legal speed limit is then based on the map information of the positioning subsystem or a seen posted speed limit sign from the computer vision subsystem. Since a posted speed limit has been seen, the posted speed limit of the sign of 90 km/h is identified as the legal speed limit. The vehicle now is able to increase its speed up to 90 km/h from the default of 70 km/h, which default speed the vehicle otherwise would be limited to if only the positioning system were being relied upon.

### Various Exemplary Scenarios

The following exemplary scenarios serve to highlight advantages of preferred embodiments of ISA systems in accordance with aspects and features of the invention.

### Scenario 1—Urban Highway Context

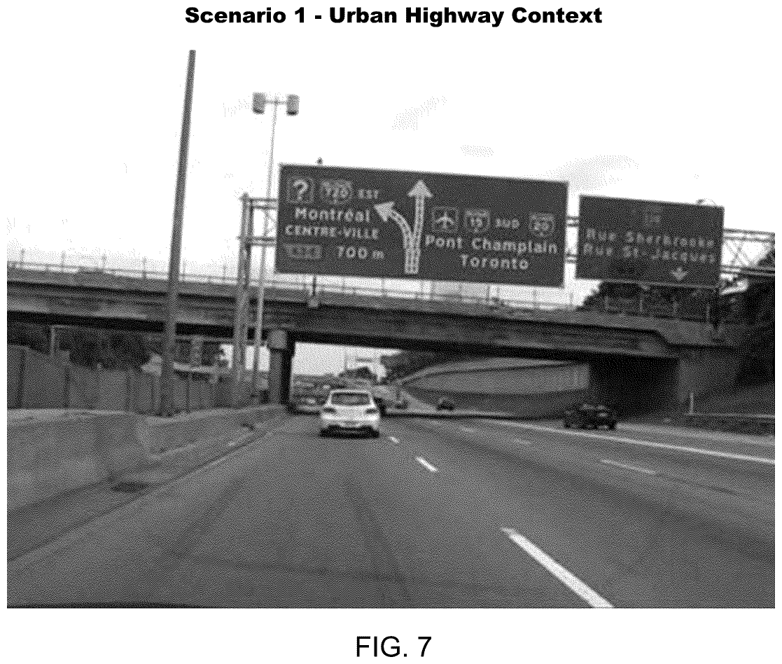

FIG. 7 illustrates a vehicle traveling in an urban highway context. With reference to this drawing, speed limits provided on maps for highways are already believed to be very reliable, and there are lots of possible distractors that a computer vision subsystem could interpret as a speed limit. It therefore is believed that there is little to gain from using a computer vision subsystem in this context for identifying legal speed limits. By being able to recognize when the vehicle is on an urban highway by using information from both the computer vision subsystem and the positioning subsystem, the ISA system provides the advantage of having predetermined logic that disables speed limit readings being used from the computer vision subsystem.

### Scenario 2—Rural Highway Context

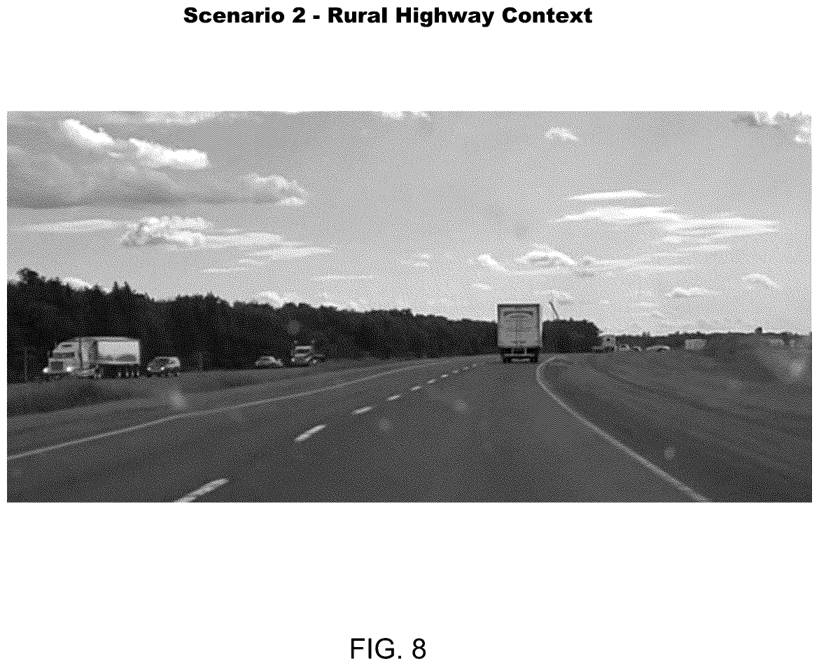

FIG. 8 illustrates a vehicle traveling in a rural highway context. With reference to this drawing, the basic behavior of the ISA system in the rural highway context should be the same as in the urban highway context. Mapping errors should be rare and speed limit readings from the computer vision subsystem can be disabled. By being able to recognize when the vehicle is on a rural highway by using information from both the computer vision subsystem and the positioning subsystem, the ISA system provides the advantage of having predetermined logic that disables speed limit readings being used from the computer vision subsystem. It further is noted that the advantage of distinguishing between a rural highway and an urban highway is that it allows a user, administrator, and/or fleet manager to give a little bit of buffer for the drivers, for instance, by allowing 70 mph in 65 mph zones, since rural and interstate/divided lane highways are typically safer than urban highways.

### Scenario 3—Road Work Context

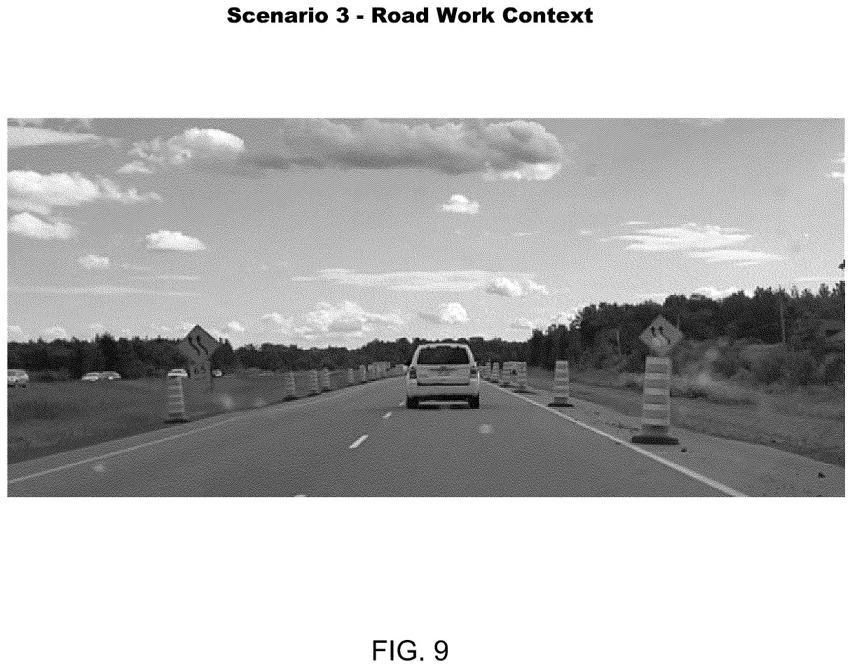

FIG. 9 illustrates a vehicle traveling in a road work context. With reference to this drawing, by being able to recognize the “road work” context using the computer vision subsystem, the ISA system provides the following advantages: for the user, administrator and/or fleet operator, the ISA system allows setting a “road work” zone speed context profile that can be applied in priority over other context profiles, such as a profile corresponding to a “rain” context; and for the user, administrator and/or fleet operator, the ISA system allows enabling the speed limits readings coming from computer vision subsystem in road work zones, thereby helping to make sure the correct legal speed limit is identified.

For instance, when the ISA system is operating on the “highway”, speed limit readings from the computer vision subsystem preferably are disabled. When the computer vision subsystem detects a few consecutive roadwork zone related elements, speed limit readings from the computer vision subsystem preferably are enabled. By doing so, if the computer vision subsystem reads a speed limit sign, then that speed limit is identified as the legal speed limit in the work zone and would be adjusted accordingly based on the speed policy that is applied and further adjusted based on the context profile for the speed zone, if applicable give the particular context priority that has been set by the user, administrator and/or fleet operator. The road work context then can be deactivated when no road work related objects are sighted by the computer vision subsystem for a configurable amount of time, e.g., after 15 seconds, while the vehicle is traveling.

### Scenario 4—Rural Area

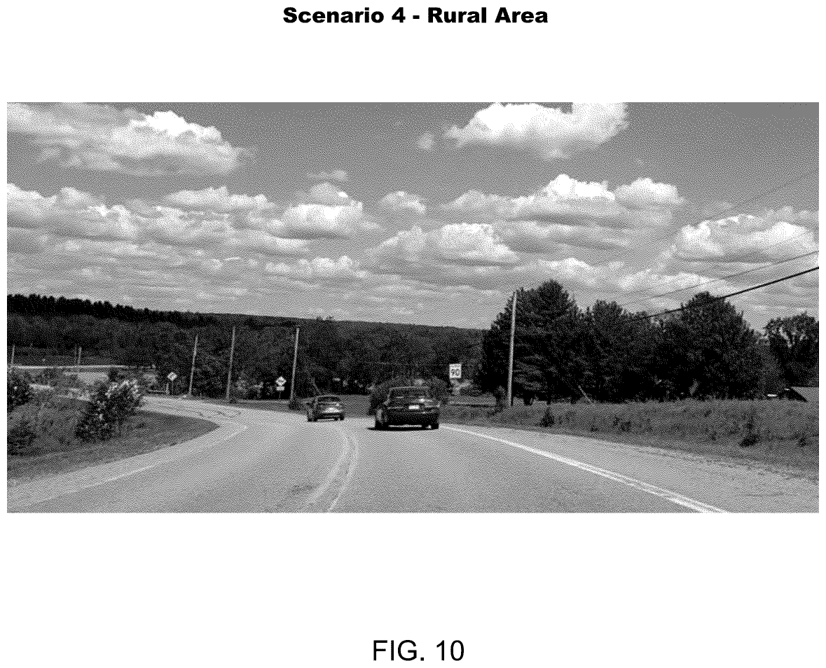

FIG. 10 illustrates a vehicle traveling in a rural area context, and FIG. 4 illustrates a process of determining a contextual speed to which to limit the vehicle using a preferred ISA system in accordance with one or more aspects and features of the invention. With reference to these figures, in rural areas map-matching positioning subsystems often provide unreliable legal speed limits that often are slower than the actual legal speed limits. This results in situations in which vehicles using a non-overridable speed limiter cannot reach legal speed limits in their travels, which translates into late deliveries, frustration for drivers, and hazardous situations for other road users. It is believed that using computer vision subsystems alone also can yield similar problems, as speed limits signs can be missing, or missed by the computer vision subsystem.

By being able to detect when the vehicle is operating in a two-lane undivided highway using the input from a computer vision subsystem and/or a positioning subsystem, which is referred to as a “rural road” or “rural area”, and by enabling speed limits readings from the computer vision subsystem in such context using the SLI logic, the preferred ISA system provides the following advantages: the ISA system allows the user, administrator and/or fleet operator to only use speed limits read by the computer vision subsystem and that are higher than speed limits provided by the map-matching positioning subsystem, thereby minimizing the risk of wrongly slowing down a vehicle; and the ISA system allows the user, administrator and/or fleet operator to output a valid speed limit based on context when the speed limits on the map are either unavailable or deemed unreliable (such as, for instance, when detecting a rural context in California, the limit should be 55 mph absent a higher priority context profile.

When a legal speed limit is not posted or is otherwise missing, the contextual speed limit for “unknown” should be set to a default value for that local jurisdiction (for instance 65 mph on a rural road in Nebraska). When the computer vision subsystem detects a speed limit sign with a higher posted value than the map-based or unknown contextual speed limit, it should set the contextual speed limit based on that higher value. The vision-based speed limit then will stay selected until the positioning subsystem detects a change in the posted speed limit, or that the type of road changes upon which the vehicle travels, etc.

### Scenario 5—Urban Area and School Zones

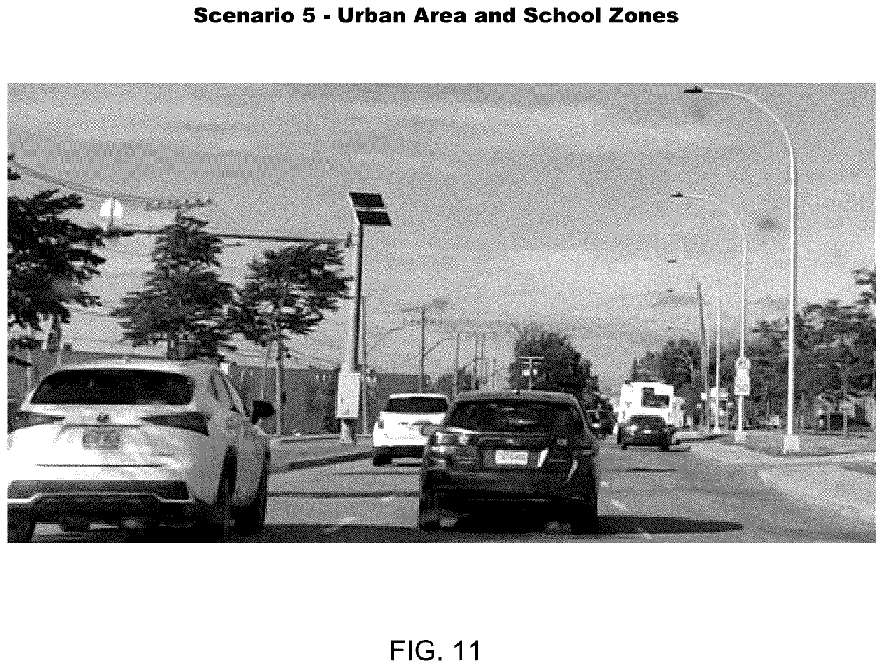

FIG. 11 illustrates a vehicle traveling in an urban area context and in a school zone context, as indicated by the street sign for a school zone. With reference to this figure, in urban areas speed limits provided with maps are less reliable than on the highway, as they change often. There are not usually lots of distractors for the computer vision subsystem with the notable exception of school zone speed limits, which can be easily confused with regular speed limits. The advantages of being able to utilize information from the positioning subsystem and the computer vision subsystem to determine if the vehicle is traveling through an urban area and/or a school zone are the following: for the user, administrator and/or fleet operator, it allows setting an alternative speed policy through a context profile for school zones, for instance, by strictly enforcing the speed limit instead of allowing a speed limit buffer as might otherwise be derived in accordance with a speed policy; and for the user, administrator and/or fleet operator, it further allows deprioritizing the context profile for the school zone during times when the school zones do not apply, such as during the night and the weekends, whereby a more relevant context profile may be applied to determine the contextual speed to which to limit the speed of the vehicle.

### Scenario 6—Hazardous Weather

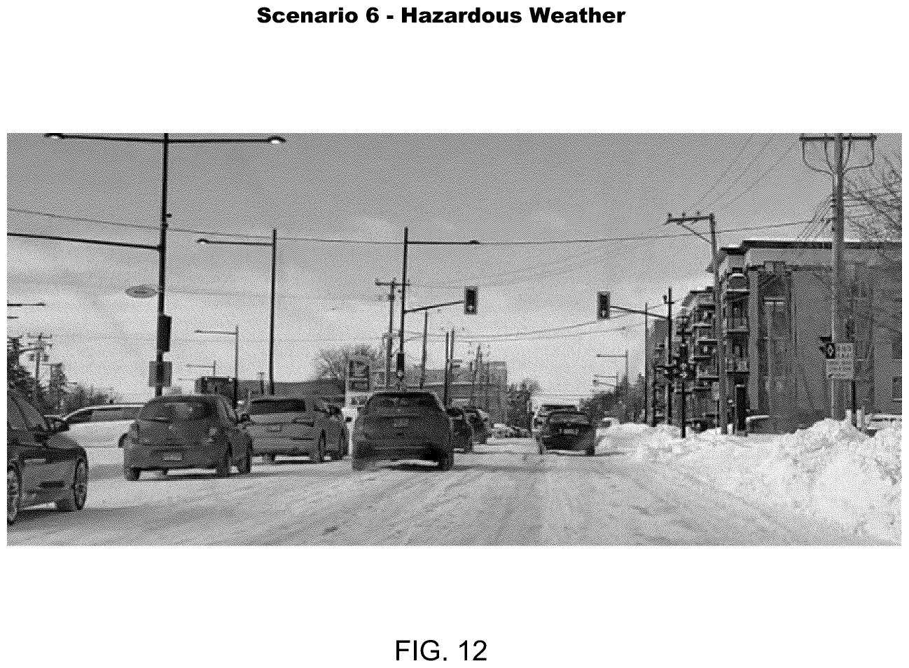

FIG. 12 illustrates a vehicle traveling in a hazardous weather context. With reference to this figure, it is believed that visual confirmation of the hazardous weather contest by the computer vision subsystem is required before implementing a context profile for hazardous weather.

The advantages of relying not just on weather reports and forecasts but also the output of from computer vision subsystem are the following: the ISA system allows the user, administrator and/or fleet operator to reliably determine if a road is likely to be hazardous; the ISA system allows the user, administrator and/or fleet operator to adjust the speed limit according to the weather conditions (such as, for instance, it is possible to reduce the maximum speed by 10% when the road is snowy or where there is heavy rain; use of the vehicle's cruise control—referenced by “CC” in the GUI of FIG. 4—also could be disabled in accordance with a context profile in order to make sure the vehicle is controlled by the driver); and the ISA system allows the user, administrator and/or fleet operator to prioritize weather information from either the computer vision subsystem or the positioning subsystem in accordance with the SLI logic.

For instance, the “slippery” context can be activated when a high probability of important precipitations (i.e. >10 mm rain, >15 cm snow) is forecasted, and when the computer vision subsystem confidently classifies the road condition as “wet” or “snowy”. In this context, the speed limit is selected as usual. A customer profile is then applied. For instance, if the selected speed limit was 75 mph, the allowed speed limit could be reduced to 70 mph.

### Scenario 7—Variable Speed Limits

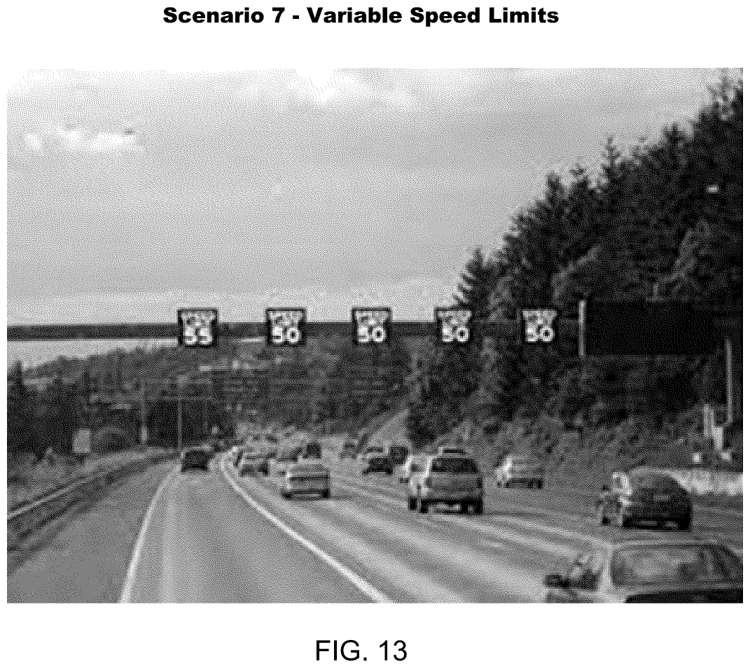

FIG. 13 illustrates a vehicle traveling in a variable speed context. With reference to this figure, map-based speed limits cannot be used in areas where variable speed limits are posted. Variable speed limits are locations where the posted speed limit can change dynamically, for instance as a function of traffic congestion, and electronic displays are used to communicate the legal speed limit to the driver in real time. The advantages of using preferred ISA systems having both information from the positioning subsystem and the computer vision subsystem are the following: the ISA system allows the user, administrator and/or fleet operator to enable the computer vision subsystem on the highway when near a variable speed sign, thus allowing the ISA system to handle variable speed limits in all situations; the ISA system allows the user, administrator and/or fleet operator to choose when to stop reading and using the variable legal speed limits; and for the user, administrator and/or fleet operator, the ISA system allows enforcing a speed policy in variable speed limit zones.

As a side note, when multiple speed limits are visible and in agreement, on the left side and the right side of the vehicle, it can be safely assumed that they apply to the current situation without having to rely on the map.

### Scenario 8—Unmapped Road

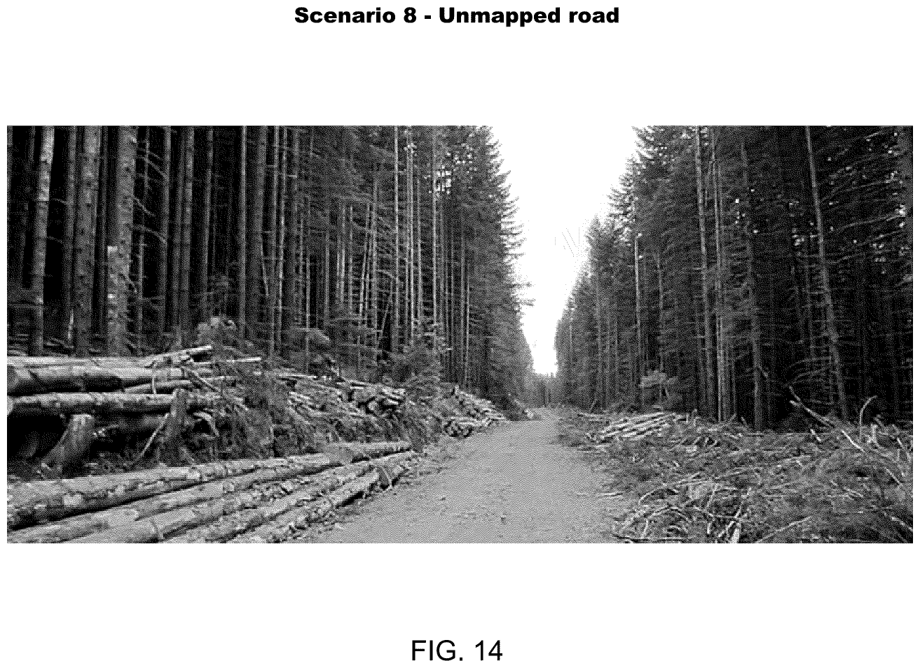

FIG. 14 illustrates a vehicle traveling in an unmapped road context. With reference to this figure, it can happen that a specific location is not mapped at all such as, for instance, in newly built areas or in recently deforested zones. In such cases, it is possible to know that the map does not have any road for a specific area. The advantages of a preferred ISA system that such a situation is able to be determined by the output from both the positioning subsystem and the computer vision subsystem and thereby enables the user, administrator and/or fleet operator to set one or more context profiles and priorities for such scenario, such as for instance: 25 mph in unmapped dirt roads; 45 mph for unmapped urban roads; and 55 mph for unmapped paved roads in rural areas.

### Scenario 9—Missing or Unreliable Speed Limit

It can happen with maps that some roads will either have no legal speed limit information or that the legal speed limit for a given road is simply deemed unreliable for some reason. In those cases, maps can still provide relevant information to help determine context, such as the type of road, and information about the road's surrounding, such as the presence of buildings or type of speed zone.

This permits the ISA system to identify implicit legal speed limits based on the positioning subsystem or the computer vision subsystem. Thus, an implicit speed limit can be identified based on a road type and knowledge of state law. For instance, in California, 25 mph in residential areas, 45 mph in urban areas, 55 mph in rural areas, and 65 mph on highways for regular vehicles, with an exception for trucks which are limited to 55 mph. The SLI logic further enables a user, administrator, or fleet operator to decide under what circumstances an implicit speed limit can be identified over a speed limit provided by a map of a positioning subsystem. Given a high confidence in the computer vision subsystem, this even enables the updating of map information based on events where the computer vision subsystem and the positioning subsystem disagree on the speed limit. Such events also can be flagged and sent to the cloud for further review to determine whether the map speed limit needs to be updated.

### Scenario 10—Steep Slope

It is well known that vehicle fuel consumption increases considerably when the inclination of the road is steep going up. The slope inclination can be derived both from the positioning subsystem and the IMU. With this information, the ISA system allows the user, administrator and/or fleet operator to set a maximum speed in a context profile based on the inclination % of the slope and prioritize the same. This maximum speed can vary according to the % of the slope in order to provide further fuel economy.

### Benefits of Preferred ISA Systems

Benefits of preferred ISA systems include improvement in the accuracy of an ISA system identifying an applicable legal speed limit. This improvement results from using SLI logic to choose when to identify the speed limit coming from the computer vision subsystem as the applicable legal speed limit, and when to identify the speed limit coming from the positioning subsystem as the applicable legal speed limit. Furthermore, the SLI logic can be updated through an online portal and deployed over the air across fleet of vehicles.

### Default Set of Rules of the SLI Logic

A default set of rules of the SLI logic can be established as follows: identify the speed limit coming from the positioning subsystem as the applicable legal speed limit on rural and urban highways, where irrelevant speed limits are likely to be seen; identify the speed limit coming from the positioning subsystem as the applicable legal speed limit in school zones, where confusion is likely regarding between a conditional speed limit with an actual speed limit; identify the speed limit coming from the computer vision subsystem as the applicable legal speed limit in situations where the risk of mistake is less, or the impact of mistakes is less, such as when traveling through roadwork zones, when speed limit signs on the right side of the vehicle agree with the speed limit sign on the left side of the vehicle, when subsequent speed limit signs have the same speed limit value, and when variable speed limit signs indicate the same speed limit for all lanes; identify the speed limit coming from the computer vision subsystem as the applicable legal speed limit when the speed limit is higher than the current speed limit coming from the positioning subsystem when traveling in rural areas; and identify the speed limit coming from the computer vision subsystem as the applicable legal speed limit when there is no speed limit coming from the positioning subsystem.

The logic rules preferably can be customized by a user, administrator and/or fleet operator. Customization may be based on experience and feedback that is gathered from ISA systems. Thus, for example, an event can be generated and forwarded to the cloud when any data source (i.e., the computer vision subsystem and map information of the positioning subsystem) are deemed to be incorrect and areas that are unmapped or incorrectly mapped and need to be updated can be flagged. Key performance indicators (KPIs) can also be monitored and multiple sets of logic compared in order to improve the same on a continuous basis. Maps also can be updated based on inputs from the computer vision subsystem when there is a high degree of confidence.

### PREFERRED CUSTOMIZATIONS

Specific customizations that are preferably available in preferred ISA systems include modifications to context profiles such as, for example, changes to a maximum speed limit according to risk factors such as road work zones, school zones, and hazardous weather in a non-overridable manner, and modifications to context priorities in order to handle situations where multiple contexts may apply. For instance, when encountering a road work zone on a snowy road, one user, administrator, or fleet manager may desire that a “roadwork zone” context profile be utilized, where another may desire that a different context profile be utilized with a different resulting contextual speed limit. Driving attributes such as whether cruise control in enabled in a context also can be modified.

Based on the foregoing description, it will be readily understood by those persons skilled in the art that the invention has broad utility and application. Many embodiments and adaptations of the invention other than those specifically described herein, as well as many variations, modifications, and equivalent arrangements, will be apparent from or reasonably suggested by the invention and the foregoing descriptions thereof, without departing from the substance or scope of the invention.

For example, the invention can be integrated with other ISA systems including, for example, the ISA systems disclosed in U.S. patent application publication 2021/0387629 that implement speed policies that are associated with driver profiles, which is incorporated herein by reference. In such scenario the context profiles and driver profiles can be integrated, with the context profiles preferably taking priority over and limiting the driver profiles when the speed limit would otherwise be greater without the context profiles.

Additionally, while the ISA system has been described as comprising one or more “databases” located at the vehicle, such term “database” should be understood as more broadly encompassing various forms for storing computer readable instructions and/or data in a non-transient manner, such as flash memory or hard drives, and without regard to a formal data structure that might otherwise be understood from the term “database”.

Accordingly, while the invention has been described herein in detail in relation to one or more preferred embodiments, it is to be understood that this disclosure is only illustrative and exemplary of the invention and is made merely for the purpose of providing a full and enabling disclosure of the invention. The foregoing disclosure is not intended to be construed to limit the invention or otherwise exclude any such other embodiments, adaptations, variations, modifications or equivalent arrangements, the invention being limited only by the claims appended hereto and the equivalents thereof.

1. A method for limiting a speed of a vehicle performed by an Intelligent Speed Adaptation (ISA) system of the vehicle, comprising the steps of:
(a) determining, at a vehicle, a current location of the vehicle as the vehicle is traveling;
(b) capturing images of the environment in which the vehicle is traveling using a camera at the vehicle;
(c) processing the captured images using one or more deep neural networks;
(d) based on an output from the one or more deep neural networks, determining a context under which the vehicle is traveling and determining a seen posted speed limit if any speed limit sign is sighted by the camera that is applicable to the vehicle as it is traveling;
(e) in accordance with speed limit identification logic, identifying a legal speed limit for the vehicle based on the determined current location of the vehicle or a determined seen posted speed limit;
(f) applying a speed policy to the identified legal speed limit to derive a practical speed limit;
(g) determining a contextual speed limit by which to limit the speed of the vehicle based on the practical speed limit and the determined context; and
(h) limiting the speed of the vehicle to the determined contextual speed limit.

2. The method of claim 1, wherein, in accordance with the speed limit identification logic, if a particular context is determined then a legal speed limit is identified based on the determined current location of the vehicle and not on a posted speed limit that is sighted.

3. The method of claim 2, wherein the particular context is at least one of the vehicle traveling along an urban highway, the vehicle traveling along a rural highway, and the vehicle traveling in a school zone.

4. The method of claim 1, wherein, in accordance with the speed limit identification logic, if a particular context is determined then a legal speed limit is identified based on a posted speed limit that is sighted and not on a legal speed limit associated with the determined current location of the vehicle.

5. The method of claim 4, wherein the particular context is at least one of the vehicle traveling in a work zone, construction zone, unmapped areas, and rural areas other than along a rural highway.

6. The method of claim 1, wherein one or more steps of the method are performed continuously.

7. (canceled)

8. The method of claim 1, wherein the limiting the speed of the vehicle to the determined contextual speed comprises outputting the contextual speed to a speed-limiting mechanism.

9. The method of claim 1, wherein the contextual speed limit is derived by applying a context profile to the practical speed limit.

10. The method of claim 9, wherein the context profile is applied in accordance with context priorities.

11. The method of claim 1, wherein the identifying of a legal speed limit for the vehicle based on the determined current location of the vehicle comprises accessing information from one or more databases maintained at the vehicle.

12. The method of claim 11, wherein the information is accessed using data representative of the determined current location of the vehicle.

13. The method of claim 11, wherein the information accessed comprises map information including one or more legal speed limits for a road segment corresponding to the determined current location.

14. The method of claim 11, wherein the information accessed from the one or more databases maintained at the vehicle is updated on a regular basis as the vehicle is traveling.

15. The method of claim 14, wherein the information in the one or more databases located at the vehicle is updated using a wireless transceiver that is configured for network communications through a network connection.

16. The method of claim 1, wherein determining a context under which the vehicle is traveling is based further on data from one or more sensors at the vehicle in addition to the captured images from the camera.

17. The method of claim 1, wherein the limiting the speed of the vehicle to the determined contextual speed limit cannot be overridden by a driver.

18. The method of claim 1, wherein the step of determining the current location of the vehicle is performed using a GNSS receiver or an IMU.

19. An ISA system for limiting a speed of a vehicle, comprising:
(a) a positioning subsystem configured to determine a current location of the vehicle as the vehicle is traveling;
(b) a situational-awareness subsystem comprising a camera configured to capture images of an environment in which the vehicle is traveling, including a speed limit sign if any is sighted by the camera that is applicable to the vehicle as it is traveling;
(c) one or more deep neural networks configured to process the captured images and configured to determine a seen posted speed limit for a sighted speed limit sign;
(d) a context estimator configured to determine a context under which the vehicle is traveling based on an output from the one or more deep neural networks;
(e) a speed limit identifier configured to
(i) identify, in accordance with speed limit identification logic, a legal speed limit for the vehicle based on the determined current location of the vehicle or the determined seen posted speed limit, and
(ii) apply a speed policy to the identified legal speed limit to derive a practical speed limit; and
(f) a context implementor configured to determine, based on both the practical speed limit and the determined context, a contextual speed by which to limit the speed of the vehicle as the vehicle is traveling and configured to output the determined contextual speed to a speed-limiting device.

20. A vehicle having an ISA system for limiting a speed of a vehicle, comprising:
(a) a positioning subsystem configured to determine a current location of the vehicle as the vehicle is traveling;
(b) a situational-awareness subsystem comprising a camera configured to capture images of an environment in which the vehicle is traveling, including a speed limit sign if any is sighted by the camera that is applicable to the vehicle as it is traveling;
(c) one or more deep neural networks configured to process the captured images and configured to determine a seen posted speed limit for a sighted speed limit sign;
(d) a context estimator configured to determine a context under which the vehicle is traveling based on an output from the one or more deep neural networks;
(e) a speed limit identifier configured to
(i) identify, in accordance with speed limit identification logic, a legal speed limit for the vehicle based on the determined current location of the vehicle or the determined seen posted speed limit, and
(ii) apply a speed policy to the identified legal speed limit to derive a practical speed limit;
(f) a context implementor configured to determine, based on both the practical speed limit and the determined context, a contextual speed by which to limit the speed of the vehicle as the vehicle is traveling; and
(g) a speed-limiting device configured to limit the speed of the vehicle to the determined contextual speed limit.

21-31. (canceled)

32. The vehicle containing the ISA system of claim 20, wherein the context implementer is configured to determine the contextual speed limit using context profiles and context priorities.

33-51. (canceled)
